(19) United States
(12) Patent Application Publication
(10) Pub. No.: US 2007/0267526 A1
(43) Pub. Date: Nov. 22, 2007

(54) Remote operated brush chipper with conspicuity light

(76) Inventors: Steven M. Uhrich, Pella, IA (US); Dale Messenger, Knoxville, IA (US); Ivan Brand, Holland, MI (US)

Correspondence Address: STURM & FIX LLP, 206 SIXTH AVENUE, SUITE 1213, DES MOINES, IA, 50309-4076, US

(21) Appl. No.: 11/434,664

(22) Filed: May 16, 2006

(51) Int. Cl. B02C 25/00

(52) U.S. Cl. 241/30

(57) ABSTRACT

A method and apparatus for enhancing safety in operating a brush chipper. A remote-enabled warning light flashes any time the brush chipper may be operated via a wireless remote control module. Workers on the ground are thereby notified the functions of the brush chipper may be changed in a manner not evident from their vantage point. Additionally, for remote operation to be enabled, two switches must both be in a remote-enable position and a feed control bar must be in neutral. Any change in these aspects will remove control from the remote module and make the machine controllable only at the controls on the brush chipper.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to brush chippers. More particularly, the present invention relates to safety features for a remote controlled brush chipper.

2. Background Art

Brush chippers are commonly used by workers keeping trees and tree branches away from utility lines, railroad tracks, and roadways. Large and small branches may be chipped into useful mulch and carted away much more conveniently than the brush in its original form.

In U.S. Pat. No. 5,088,532, Eggers et al., which is hereby incorporated by reference, disclosed an automatic material feed control system for a brush chipper. The disclosed chipper includes feed rollers and a chipper drum. This brush chipper was operated at the machine rather than remotely.

Chippers are operated locally, that is, at the machine, by a feed control bar having a plurality of positions. A patent application to Bouwers, et al., Ser. No. 11/172,209, filed Jun. 30, 2005, now U.S. Pat. No. ______, is also hereby incorporated by reference. The invention disclosed in Ser. No. 11/172,209 comprises a four-position feed control bar and a lower feed stop bar for operating the chipper at the feed table. A patent application to Stelter et al., U.S. Ser. No. 10/724,992, now U.S. Pat. No. 7,011,258, is also incorporated herein by reference which also discloses a lower feed stop bar.

Large brush chippers available today are used for brush that is large enough that it is difficult to feed manually. It is thus frequently loaded into the brush chipper with mechanical assist such as a skid loader or similar machine. In this operating mode there often are no operators in the immediate vicinity of the brush chipper. In such a case, the brush chipper is preferably operated remotely, so the skid loader operator may operate the chipper from the seat of the skid loader.

The skid loader operator may need to control various functions of the chipper in order to effectively chip large brush, which is often not only heavy, but often times bulky. The bulky brush can interfere with operation of the machine, for instance by inadvertently tripping the lower feed stop bar. After such an inadvertent trip, remote operation of the chipper, such a remote override of the lower feed stop bar, will enable the skid loader operator to control the machine as necessary to continue the operation without having to leave the skid loader, as would otherwise to be required.

When more than one worker is present at the chipper, wherein there is an operator working from the ground in addition to the skid loader operator, the chipper may be operated remotely and locally. Workers who are in close proximity to the chipper when it is operated remotely may be subjected to hazards.

There is, therefore, a need for a method and apparatus for improving the safety of workers close to a brush chipper that may be operated remotely. More specifically there is a need for a system that enables remote override of a lower feed stop bar, while providing for a way for a local worker, located at the machine, to operate the chipper in a safe manner.

### BRIEF SUMMARY OF THE INVENTION

It is an object of the present invention to provide a remotely activated bottom bar bypass system that enables an operator, at a remote location, to control the chipper including a remote enable selector at the machine, a remote hold to run switch on a remote control and a safety light to warn workers close to the brush chipper that the chipper is, or may be, operated remotely.

In the preferred embodiment of the invention, the remote enable light is an amber strobe light. When the local controls on the chipper are configured to permit remote operation, and after the remote module has been configured to control the chipper, the remote enable light flashes repeatedly as long as the chipper may be operated remotely. If either the remote module or the chipper controls are reconfigured to disallow remote operation, the remote enable light ceases to flash.

An additional object of the invention is a remote-enable switching system wherein workers on foot near the chipper may disallow remote operation of the chipper.

To configure the local controls on the chipper for remote operation, the upper feed control bar must be in its neutral position. Two mushroom switches are located on opposite sides of the chipper. Both mushroom switches must be pulled out in order to permit remote operation. During remote operation, if either of the mushroom switches is pushed in, or if the upper feed control bar is pushed out of its neutral position, remote operation is immediately disabled. Hence, if a local worker detects an emergency, either of these actions will put the chipper into local operation-only mode, so the emergency may be addressed. The local worker is not in danger of the chipper being operated remotely and causing the local worker to be in danger, thereby.

Still another object is to require a security code to be entered into the remote module before remote operation is enabled. A conscious action must be taken to enable the remote module to control the chipper. In this way, a remote operator may take notice of the location and actions of any workers local to the chipper before taking charge of the chipper's operation, and the remote operator must be familiar with the machine, as demonstrated by knowledge of the correct code. After the security code is entered, and if the mushroom switches are pulled out and the upper feed control bar is in its neutral position, the remote enable light begins to flash to warn the local workers of the remote operation of the chipper.

### BRIEF DESCRIPTION OF THE DRAWINGS

FIG. 1 is a perspective view of a brush chipper including the safety features of the present invention;

FIG. 2 is a perspective view of a portion of the brush chipper, with portions broken away to show some of the internal parts of the chipper;

FIG. 3 is a side elevation view of a portion of the brush chipper, showing some of the safety features of the present invention;

FIG. 4 is a remote module, used to operate the chipper remotely;

FIG. 5 shows an overlay for the remote module having a plurality of operations; and

FIG. 6 is a wiring schematic for the remotely operated chipper of the present invention.

### DETAILED DESCRIPTION OF THE INVENTION

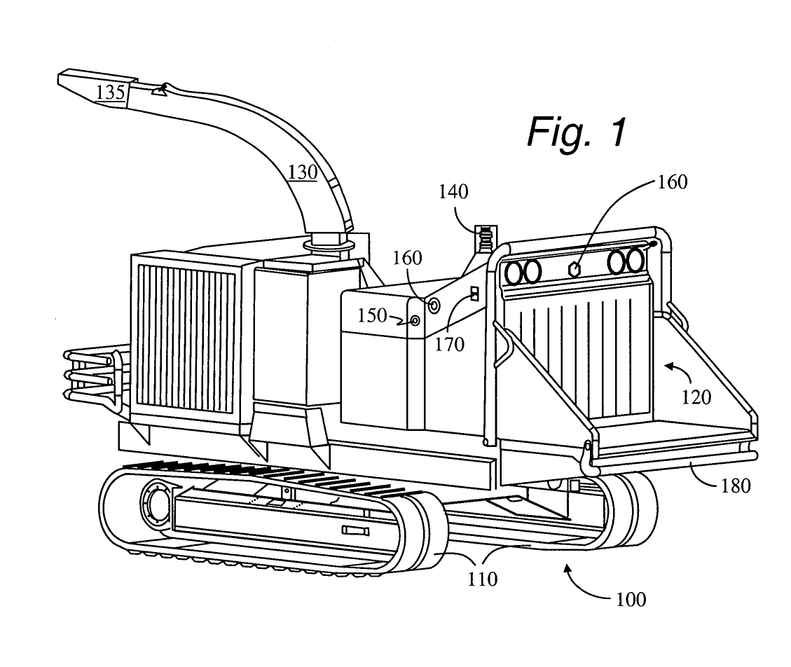

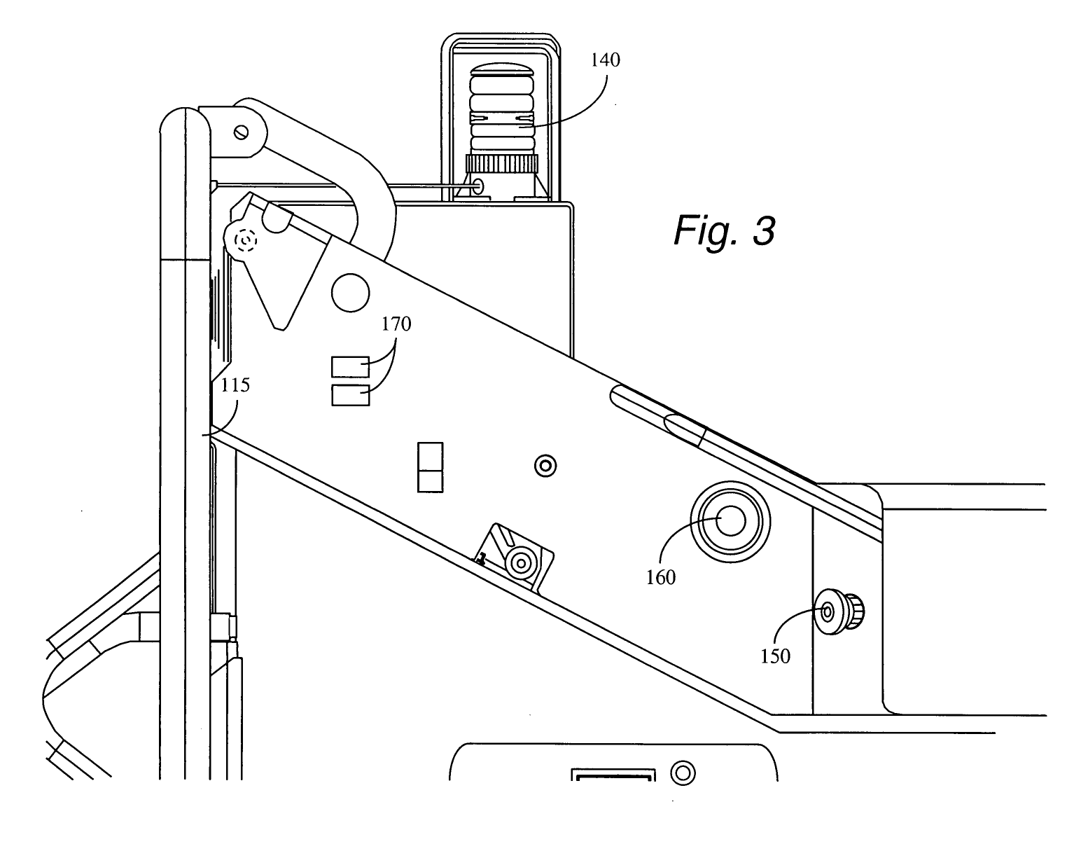

A brush chipper 100 featuring wireless remote operation capabilities and associated safety aspects is shown in FIGS. 1-3. The brush chipper 100 is moved from place to place on a set of tracks 110. Control of the actuation of the tracks 110 may be accomplished locally and remotely.

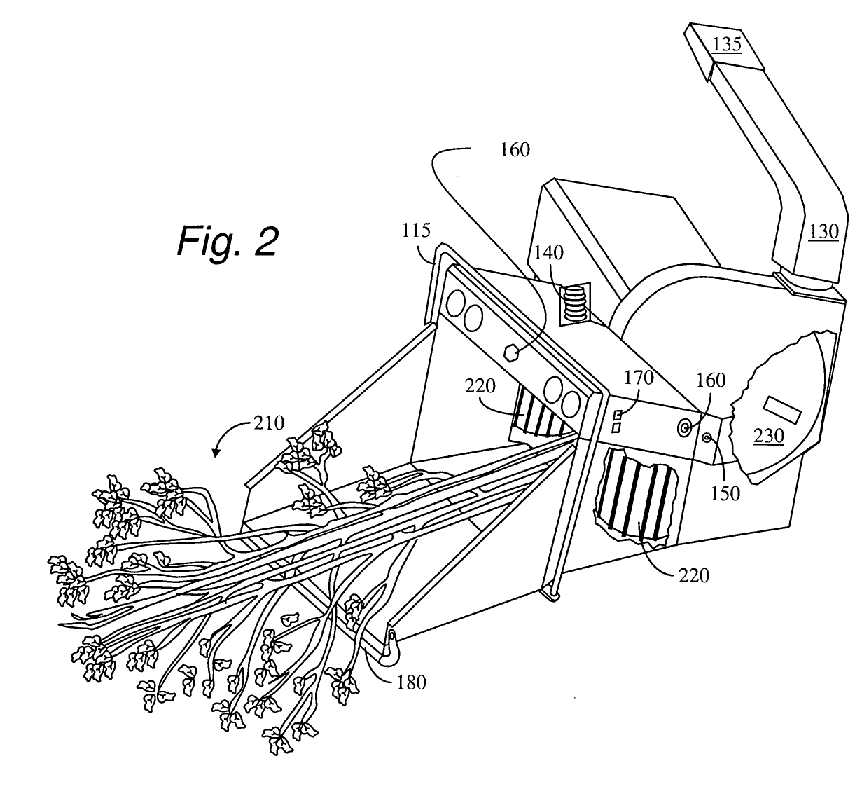

Brush and wood 210 are loaded into the infeed area 120 and drawn in by feed rollers 220. The chipping actually occurs at a chipping drum or disk 230. FIG. 2 shows a chipping disc, but machines with drums are also common. The feed rollers 220 and the chipping drum or disk 230 may both be controlled locally and remotely. Local controls of the feed rollers 220 include a lower feed control bar 180, which may be actuated by an operator in an emergency situation to stop the feed rollers 220, and an upper feed control bar 115, which is routinely used to engage, disengage, and reverse the feed rollers 220.

Chipped matter is expelled from the brush chipper 100 via a spout 130, preferably having a deflector 135. The spout 130 may be aimed with local controls and remote controls.

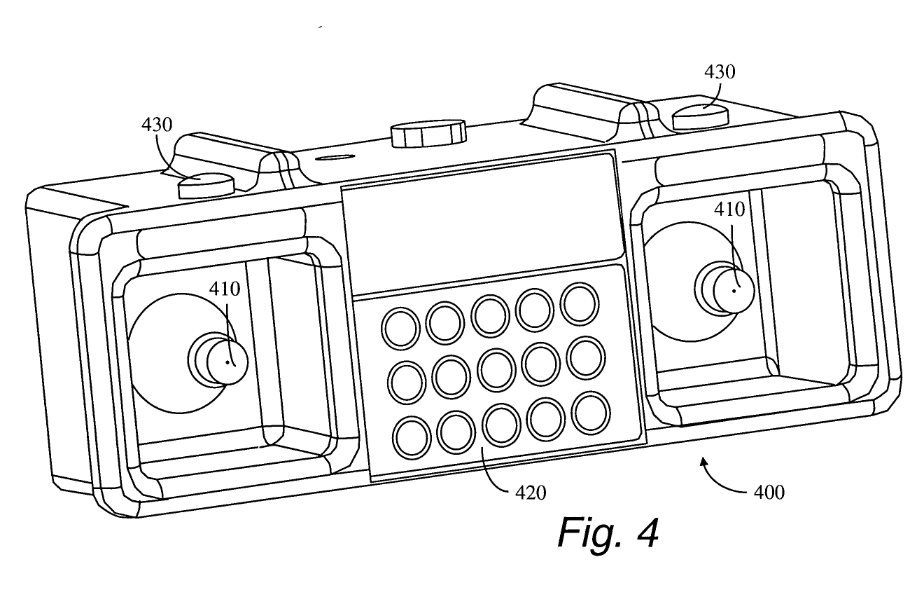

A remote enable strobe light 140 is mounted on the brush chipper 100 to be visible from almost any angle. The remote enable light 140 flashes whenever the remote module 410 (see FIG. 4) is enabled to operate the brush chipper 100. In the preferred embodiment, the remote enable light 140 is amber in color and is a strobe light. However, the present invention is not limited to the color or lighting sequence of the remote enable light 140.

Two mushroom switches 150 are located on opposite sides of the brush chipper 100. Both mushroom switches 150 must be pulled out, and the upper feed control bar 115 must be in its neutral position in order to permit remote operation. During remote operation, if either of the mushroom switches 150 is pushed in, remote operation is immediately disabled. Additionally, if the upper feed control bar 115 is removed from its neutral position, remote operation is immediately disabled.

Other controls provided locally on the chipper 100 include a hold-to-run switch 160, providing an operator an opportunity to override a stop condition caused by a tree branch contacting the lower feed control bar 180, for instance. The hold-to-run switch 160 must be depressed and held by the operator all the time the stop condition is overridden.

Another control located on the chipper 100 is a lower feed control bar sensitivity switch 170. The lower feed control bar 180 causes a stop condition when it is engaged by a branch or an operator. The sensitivity of this lower feed control bar 180 is adjustable via the lower feed control bar sensitivity switch 170. In its high sensitivity position, the lower feed control bar 180 will more readily stop the feed rollers 220 than in the lower sensitivity setting.

A wireless remote control system is included as part of the brush chipper 100. A wireless remote module 400 is shown in FIG. 4, and is used by an operator at a location remote from the brush chipper 100. Often, the use of the remote module 400 is by an operator that is transporting the chipper. Joy sticks 410 are provided to maneuver the brush chipper 100 via the tracks 110. As with most tracked vehicles, the tracks 110 are powered independently, so while one track 110 is turning forward, the other track 110 may be turning forward, backward, or stopped. Having the joysticks, used to control the tracks, on the remote control module allows the operator to stay away from the machine, to avoid potential hazards inherent with the movement of the chipper.

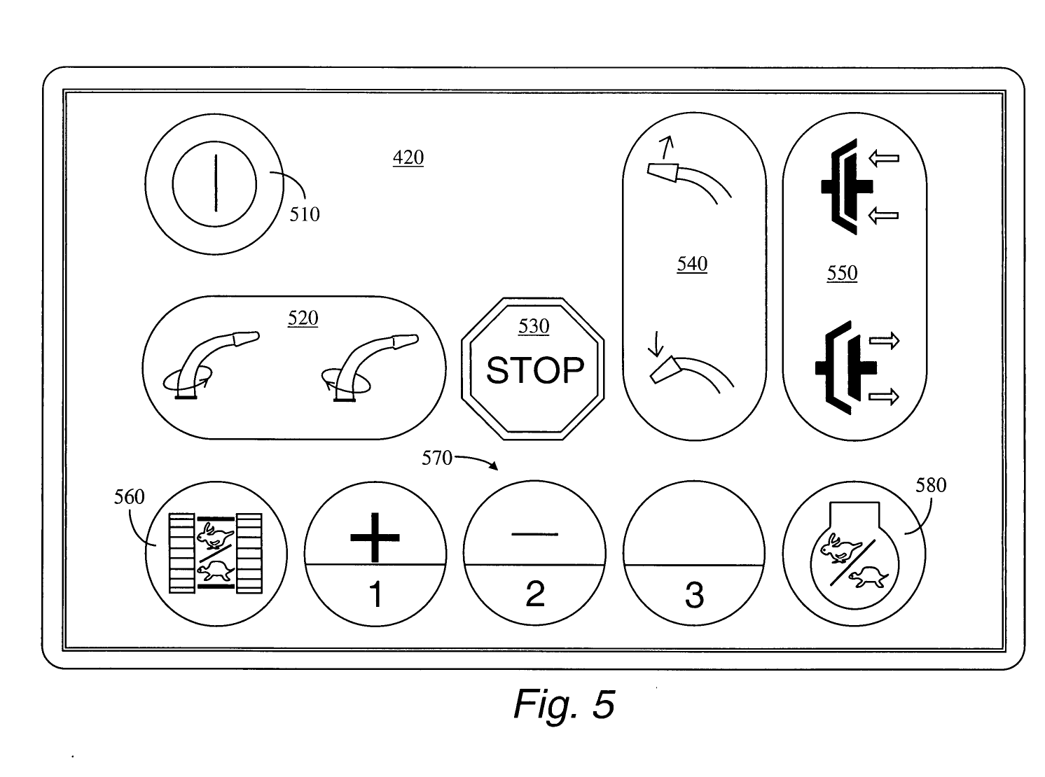

Other machine functions can also be controlled with the remote module, for which a control panel 420 is also provided, an example of which is shown in FIG. 5. The control panel 420 is constructed to be installed on the remote module in the space between the joysticks as shown in FIG. 4. The functions provided by the controls included on the control panel 420 shown in FIG. 5 include start control 510 to start the engine; rotation control 520 to rotate the discharge spout; stop control 530 which stops the engine, and ultimately also stops the feed wheels 220, and chipping disk 230; deflector control 540 which controls the orientation of the deflector; clutch engage/disengage 550 which controls a clutch that stops or starts the cutter drum or disc; speed control 560 which allows selection of a gear ratio providing either fast or slow track speed; number keypad 570 with which to enter the security code to enable remote operation and for selection and storing of configuration variables, and speed control 580 which allows selection of either high engine rpm or low engine rpm. These controls are typically used in preparation for, and in advance of performing chipping.

Another control on the remote module 400 is the hold-to-run control 430 as shown in FIG. 4, which is typically used during the chipping operation, particularly when the remote operator may also be operating a separate loader machine. Two hold-to-run buttons 430 are included for convenience. The function of these hold-to-run buttons 430 is the same as the hold-to-run switch 160 on the brush chipper 100, while the machine configuration must be different in order for the remote hold to run controls to work. In order for the remote hold to run controls to work, the machine must be placed in a configuration for remote operation.

To configure the local controls on the brush chipper 100 for remote operation, the upper feed control bar 115 must be in a neutral position. The two mushroom switches 150 must be pulled out, that is, away from the body of the brush chipper 100 in order to permit remote operation. During remote operation, if either of the mushroom switches 150 is pushed in, or if the upper feed control bar 115 is pushed out of its neutral position, remote operation is immediately disabled.

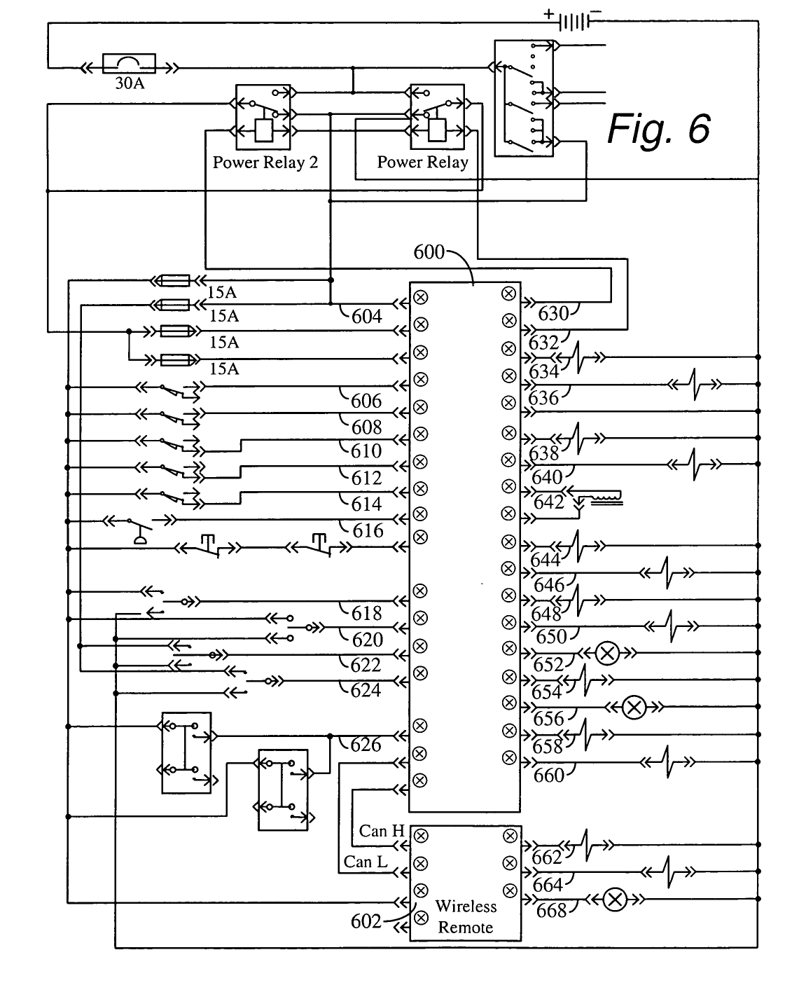

A wiring schematic is shown in FIG. 6, focusing on the microprocessors, 600, 602, wherein the microprocessor 602 is associated with the wireless remote operation of the brush chipper 100. The following describes the pinouts for the two microprocessors, 600, 602 as illustrated in FIG. 6:
604 Ignition switch on
606 Forward feed switch
608 Reverse feed switch
610 Emergency stop switch
612 Normal sensitivity switch
614 Reduced sensitivity switch
616 Hydraulic over-pressure switch
618 Sensitivity select switch
620 Engine droop setting switch
622 Chute rotate switch
624 Deflector up/down switch
626 Reset/hold-to-run switches
630 Power relay 2
632 Power relay
634 Forward left track solenoid
636 Reverse left track solenoid
638 Forward right track solenoid
640 Reverse right track solenoid
642 Engine speed sensor
644 Reverse feed solenoid
646 Reverse feed solenoid
648 Winch enable solenoid
650 Clutch engage solenoid
652 Normal sensitivity light
654 High track speed solenoid
656 Info light
658 Chute rotate counter clockwise solenoid
660 Chute rotate clockwise solenoid
662 Deflector up solenoid
664 Deflector down solenoid
668 Remote beacon light

The above embodiments are the preferred embodiments, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

We claim:

1. A method of controlling a brush chipper wherein the brush chipper comprises a remote module, a feed control bar, and a switch, the method comprising:
positioning the switch in a remote-enable position;
positioning the feed control bar in a neutral position;
enabling communication with the brush chipper via the remote module; and
disabling the communications between the remote module and the brush chipper in an event selected from the group consisting of: repositioning the switch and repositioning the feed control bar.

2. The method of claim 1 wherein the switch comprises a first switch and wherein the brush chipper additionally comprises a second switch, and further wherein disabling the communications between the remote module and the brush chipper comprises disabling the communications between the remote module and the brush chipper in an event selected from the group consisting of: repositioning the first switch, repositioning the second switch, and repositioning the feed control bar.

3. The method of claim 1 wherein enabling communication with the brush chipper via the remote module comprises:
entering a security code at the remote module; and
operating feed rollers in the brush chipper from the remote module.

4. The method of claim 1 wherein the brush chipper additionally comprises a remote-enable warning light, the method additionally comprising:
energizing the remote-enable warning light after enabling communication with the brush chipper via the remote module; and
deenergizing the remote-enable warning light after disabling the communications between the remote module and the brush chipper.

5. The method of claim 1 wherein energizing the remote-enable warning light comprises causing the remote-enable warning light to flash.

6. A method of controlling a brush chipper wherein the brush chipper comprises a remote module, a feed control bar, a remote-enable warning light, and a switch, the method comprising:
positioning the switch in a remote-enable position;
positioning the feed control bar in a neutral position;
enabling communication with the brush chipper via the remote module;
energizing the remote-enable warning light; and
chipping brush in the brush chipper;
disabling the communications between the remote module and the brush chipper in an event selected from the group consisting of: repositioning the switch and repositioning the feed control bar.

7. The method of claim 1 wherein the remote module comprises a wireless remote module.

8. An apparatus for controlling a brush chipper having remote control capability, the apparatus comprising:
a remote module that may be removed, physically, from the brush chipper and used for remote operation of the brush chipper;
a remote-enable switch, a first position of said remote-enable switch used to disable remote operation of the brush chipper while a second position of said remote-enable switch used to enable remote operation of the brush chipper; and
a feed control bar having a neutral position, said feed control bar being positioned in its neutral position to enable remote operation of the brush chipper and the feed control bar being positioned in any other position to disable remote operation of the brush chipper.

9. The apparatus of claim 8 wherein the remote-enable switch comprises a first remote-enable switch, the apparatus additionally comprising a second remote-enable switch wherein both the first remote-enable switch and the second remote-enable switch must be in respective predetermined remote enable positions to enable remote operation of the brush chipper and wherein if either of said first remote-enable switch or said second remote-enable switch is not it its respective predetermined remote enable position, remote operation is disabled.

10. The apparatus of claim 8 additionally comprising a remote-enable warning light, wherein said remote-enable warning light is energized whenever remote operation of the brush chipper is enabled.

11. The apparatus of claim 8 wherein the remote module comprises:
a keypad; and
a microprocessor to receive a security code entered at the keypad and comparing the security code to a standard security code to enable remote operation.

12. An improvement to a brush chipper that includes a feed table, powered feed rollers, a feed stop bar located at the leading edge of the feed table, and a bypass switch that overrides the stop signal produced by the feed stop bar the improvement comprising a remote control that includes a bypass switch that provides a bypass signal to the chipper, a warning light mounted to the brush chipper for warning when the machine can be controlled remotely, and a remote enable switch mounted to the brush chipper that allows the remote control to be enabled or disabled.
